(19) United States
(12) Patent Application Publication
(10) Pub. No.: US 2006/0155640 A1
(43) Pub. Date: Jul. 13, 2006

(54) Product optimizer

(76) Inventors: Christopher Kennedy, West Palm Beach, FL (US); Bryan Hurley, West Palm Beach, FL (US); William C. Erbey, West Palm Beach, FL (US)

Correspondence Address: ARENT FOX PLLC, 1050 CONNECTICUT AVENUE, N.W., SUITE 400, WASHINGTON, DC, 20036, US

(21) Appl. No.: 11/301,247

(22) Filed: Dec. 13, 2005

Related U.S. Application Data
(63) Continuation-in-part of application No. 10/937,879, filed on Sep. 10, 2004.
(60) Provisional application No. 60/502,273, filed on Sep. 12, 2003.

(51) Int. Cl. G06Q 40/00

(52) U.S. Cl. 705/39

(57) ABSTRACT

A system and method for defining a custom business process associated with a financial transaction. Defining a business process includes creating one or more forms for exchanging information among a customer, a financial institution, and, optionally, a vendor or other third-party who performs one or more sub-transactions related to the financial transaction. The system and method of the present invention provide for customizing each form to include one or more data elements associated with the financial transaction. The selected data elements are subsequently used to define logical relationships for automating order placement of sub-transactions. The logical relationships are triggered by one or more predetermined events. Once triggered, the logical relationships are applied, and the result or outcome is used to perform other tasks associated with the financial transaction automatically.

### CROSS-REFERENCE TO RELATED APPLICATIONS

This application claims priority to applicants' copending U.S. Nonprovisional application Ser. No. 10/937,879 entitled “METHOD AND SYSTEM FOR VENDOR MANAGEMENT” filed Sep. 10, 2004, which claims priority to Provisional Application Ser. No. 60/502,273 entitled “METHOD AND SYSTEM FOR VENDOR MANAGEMENT” filed Sep. 12, 2003. The entirety of each of the above-mentioned patent applications are incorporated herein by reference in their entirety.

### BACKGROUND OF THE INVENTION

1. Field of the Invention

The present invention relates to a method and system for defining a workflow of a financial transaction to automate and manage sub-transactions associated therewith.

2. Background of the Technology

There exist in the art paper-based methods and systems for completing financial transactions, such as providing mortgages, but these systems are typically slow, costly, and labor-intensive. Computer-implemented systems to manage financial transactions are also known, but these systems typically do not contain functionality to manage each step in the lifespan of an entire financial transaction. Moreover, present computer-implemented systems do not provide functionality to initiate or track sub-transactions that are necessary for the completion of a financial transaction. Further, present computer-implemented systems do not provide functionality to a system user (also interchangeably referred to as an employee, agent, or affiliate of a financial institution) for defining the sequence of events to be performed in a custom defined workflow (also referred to interchangeably herein as “business process” or “custom workflow”) associated with a financial transaction.

Therefore, there is an unmet need in the art for a method and system for managing financial transactions that includes functionality to define a custom workflow to suit the individual needs of a particular system user. Particularly, there is an unmet need for a method and system for defining a custom workflow that automatically determines and orders one or more sub-transactions associated with the overall financial transaction. Moreover, there is an unmet need for a method and system for defining a custom workflow for automatically advancing the financial transaction to completion, without the need of continuous oversight by the system user.

### SUMMARY OF THE INVENTION

The present invention relates to a method and system for creating a business process for electronically facilitating a business transaction between a financial institution and an end user (also interchangeably referred to herein as a customer), wherein the business transaction optionally includes one or more sub-transactions among a vendor and a customer, a vendor and a financial institution, or between a customer and a financial institution. The method and system include a user interface that allows a financial institution to define a business transaction case file using a plurality of different fields. The financial institution utilizes the different fields to define logical relationships (also interchangeably referred to herein as “decision rules”) associated with the financial transaction. Application of the decision rules causes the business process to automatically determine the need for, and trigger, subsequent orders or sub-transactions, based on the needs and preferences of the customer and the requirements of the financial transaction.

According to one embodiment of the present invention, the method and system include inputting one or more data elements into a standardized reference file, such as a database or other data repository, and creating a new business process corresponding, for example, to a desired type of financial transaction. The system user then selects one or more data elements corresponding to information utilized in the business process. The data elements are subsequently used to define one or more forms associated with the business process and one or more decision rules for determining the need for, and triggering, subsequent events, such as ordering one or more sub-transactions related to the business process. One or more of the data elements contained in the one or more forms define the decision rules. The system user then may select one or more actions to be performed upon application of the decision rules. The actions may include, for example, ordering an additional sub-transaction, canceling the business process, or performing some other activity related to the business process.

In one embodiment, the one or more data elements include, for example, File level information, which includes basic borrower information, such as a borrower's name, address, telephone number, Social Security Number, and other information. The one or more data elements may also include Order level information, which includes, for example, detailed transaction-related information, such as, in the case of a loan transaction, credit scores, a desired loan amount, desired interest rate, repayment terms, and other information. The one or more forms may include, for example, an order form for ordering a sub-transaction, an order confirmation form for confirming one of acceptance, conditional acceptance, or denial of the sub-transaction, and an order fulfillment form for communicating an outcome of the sub-transaction.

In one embodiment, the one or more decision rules are defined so as to compare one data element to another or to compare one data element to a numerical value. The decision rules are applied, for example, when an order is placed, an order is canceled, an order is confirmed, an order is fulfilled, or an order is declined. The events triggered as a result of applying the decision rules may include, for example, ordering a transaction, ordering a sub-transaction, canceling a sub-transaction, or declining a sub-transaction.

According to another embodiment of the present invention, the business process may be used to electronically facilitate a transaction between the financial institution and the customer. The business process may include, for example, desire for inputting one or more data elements into a standardized reference file, such as a database; a device for selecting a plurality of data elements for use in the business process; a device for creating at least one form including at least one of the plurality of data elements for use in the business process; a device for creating at least one decision rule using the at least one of the plurality of data elements; a device for selecting one or more triggering events to trigger application of the at least one decision rule; and a device for specifying one or more activities to be performed upon an outcome of the at least one decision rule.

According to a further embodiment, the present invention relates to a computer program product including a computer usable medium having control logic stored therein for causing a computer to facilitate a transaction between a financial institution and the customer. The control logic of the computer program product may include, for example, a first computer readable program code means for inputting a plurality of data elements into a standardized reference file, e.g., a database, and a second computer readable program code means for selecting at least one of the plurality of data elements for use in the financial transaction. The plurality of data elements may include, for example, File level information, e.g., basic borrower information, such as a borrower's name, address, telephone number, Social Security Number, and other information. The plurality of data elements may also include Order level information, e.g., detailed transaction-related information, such as, in the case of a loan transaction, credit scores, a desired loan amount, desired interest rate, repayment terms, and other information.

In another embodiment, the control logic may also include a third computer readable program control means for creating one or more forms. Each form contains one or more of the plurality of data elements. Further, the forms may include, for example, an order form for ordering a sub-transaction, an order confirmation form for confirming acceptance, conditional acceptance, or denial of the sub-transaction, and an order fulfillment form for communicating an outcome of the sub-transaction.

In one embodiment, the control logic may also include a computer readable program code control means for creating one or more decisions rules, for selecting one or more triggering events to trigger application of the decision rules, and for specifying one or more activities to be performed upon a specific outcome of the application of the decision rules. The decision rules are defined so as to compare one data element to another or to compare one data element to a numerical value. The decision rules are applied, for example, when an order is placed, an order is canceled, an order is confirmed, an order is fulfilled, or an order is declined. Events triggered as a result of applying the decision rules may include, for example, ordering a transaction, ordering a sub-transaction, canceling a sub-transaction, or declining a sub-transaction.

Additional aspects, advantages, and novel features of the invention will be better understood as set forth in the following description and accompanying drawings and will also become apparent to those skilled in the art upon examination of the following or upon learning by practice of the invention.

### BRIEF DESCRIPTION OF THE FIGURES

The features of the invention will be more readily understood with reference to the following description and the attached drawings, wherein:

FIG. 1 shows various features of an example computer system for use in conjunction with an embodiment of the present invention;

FIG. 2 presents an exemplary system diagram of various hardware components and other features, in accordance with an embodiment of the present invention;

FIG. 3 is a block diagram of various system components, in accordance with an embodiment of the present invention;

FIG. 4 presents an example flow diagram of functions performed in accordance with an embodiment of the present invention; and

FIGS. 5-9 show sample Graphical User Interface (“GUI”) screens presented to a system user in conjunction with an embodiment of the present invention.

### DETAILED DESCRIPTION

The present invention provides a system and method for defining a custom workflow associated with a financial transaction. In one embodiment of the present invention, defining a custom workflow may include creating one or more forms for exchanging information among a customer, a financial institution, and, optionally, a vendor or other third-party for performing one or more sub-transactions related to the financial transaction. The system and method of the present invention provide, in one embodiment, for customizing each form to include one or more informational fields associated with the financial transaction, such as customer information, the particular type of financial transaction at issue, related sub-transactions (also referred to interchangeably herein as “products”), and other information. Sub-transactions include, for example, actions that are required or desired to complete the financial transaction. Upon selection of one or more informational fields, these fields may be subsequently utilized to define logical relationships for automating order placement of sub-transactions (also interchangeably referred to herein as “Automated Ordering Functionality”). The logical relationships are triggered, in one embodiment, by one or more predetermined events. Once triggered, the logical relationships are applied, and the results or outcomes are utilized to perform other transaction-related tasks automatically. For example, the outcome of the one or more logical relationships can include ordering sub-transactions or terminating the transaction.

In one embodiment, the Automated Ordering Functionality offers full end-to-end order placement automation, without the need for intervention by an end user. This feature reduces customer costs due to the reduction in manual processes, and also reduces errors in product ordering (e.g., ordering an inappropriate set of products for a specified financial transaction).

The Automated Ordering Functionality allows the financial institution, in one embodiment, to utilize File and Order data (described in more detail below) to determine which products to order and when to order them. For example, a customer is able to order Broker's Price Opinion (“BPO”) for loans with a loan type of “refinance,” and to order a full appraisal for loans with a loan type of “purchase.” As explained above, the functionality is designed to combine comparison logic to automate the order placement process. For instance, a customer may want loans with a loan-to-value ratio (“LTV”) greater than 95%, and with a loan product of “home equity line of credit” (“HELOC”), to be handled differently as compared to loans with a loan-to-value ratio (“LTV”) less than 95% and loan product of “conforming.” Essentially, the Automated Ordering functionality may handle the typical decision-making scenarios that a customer may face on a daily basis.

To maximize the effectiveness of Automated Ordering functionality, one embodiment of the present invention offers automated product selection and order placement capabilities for various scenarios, such as file creation and order fulfillment.

The file creation scenario enables a customer to trigger the automated product selection and order placement at the time a file is created. Under this scenario, File level data, in one embodiment, is utilized to determine the appropriate products to order for the specified file. The File level data includes typical order placement data, such as Premium Type, Rate Type, and Renewal Type for the Mortgage Insurance product. File level data may also include, for example, a borrower's name, address, credit rating, employment status, employer information, and other information.

In one embodiment, the order fulfillment scenario enables automatic product selection and order placement based on order fulfillment data. Under this scenario, order fulfillment data is utilized to determine the appropriate products to order for the specified file. As an example of the order fulfillment scenario, a customer may order an automated valuation model (“AVM”) product and a BPO will be ordered if the AVM fulfillment Property Value is, for example, more than 90% of the Estimated Property Value.

In one embodiment, automated product selection enables a financial institution to create custom decision rules to automatically place orders for required products. The decision rules may be based, for example, on “if-then” logic and can include any data element, such as loan data (pre-fulfillment data), indicating the type of loan or other transaction; fulfillment data, indicating which orders have been completed; or file/order status data, indicating the status of outstanding orders.

In one embodiment, loan data (pre-fulfillment data) may indicate the type of loan or other transaction. Loan data may also include data indicating which products to order for the transaction. Loan data may trigger, for example, the automatic ordering of necessary products based on File level data or other transaction data. As a result, automated ordering based on loan data eliminates or greatly reduces the level of effort for the product ordering decision process.

In one embodiment, fulfillment data indicates which orders have been completed. Fulfillment data may trigger, for example, the ordering of subsequent products based on the results for fulfillment data. Thus, if an AVM value is delivered and is greater than a predetermined value, such as the percentage of the original appraised value, a BPO may automatically be ordered. Automated ordering based on fulfillment data eliminates the manual processing that occurs when products are fulfilled. For example, if the product is rejected, the order is automatically placed with a different vendor. As another example, if the fulfillment data does not meet the acceptance rules, an alternative product is automatically ordered.

In one embodiment, file/order status data indicates the status of outstanding orders. File/order status data may trigger, for example, automatic ordering of alternative or supplemental products based on the result of specified status changes. For example, when a mortgage loan is funded, a mortgage insurance (“MI”) policy can automatically be activated, and a flood zone determination can be automatically upgraded from a one-time to a life-of-loan. Automated ordering based on file/order status data eliminates the manual processing that occurs when the status of a file or order changes.

Example embodiments will now be described in conjunction with the following figures.

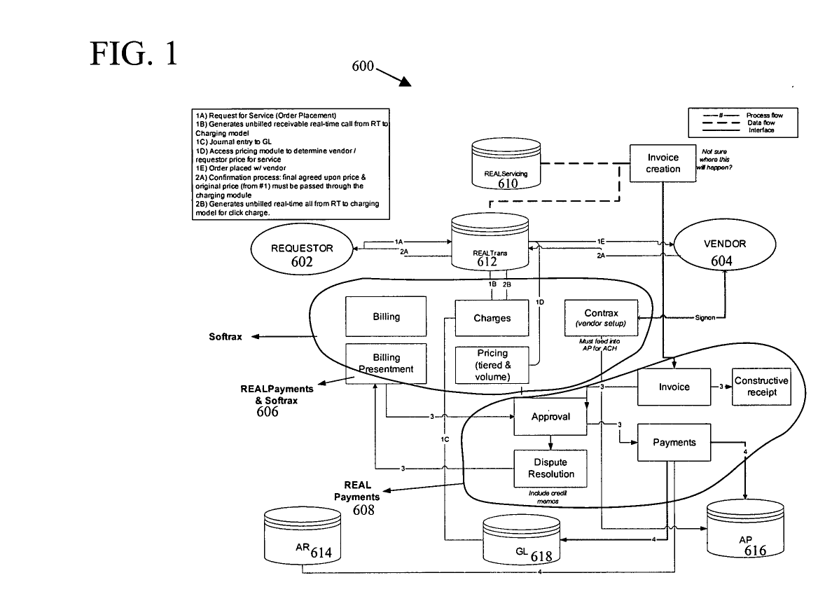

FIG. 1 shows various features of an example computer system 600 for use in conjunction with an embodiment of the present invention. As shown in FIG. 1, the computer system is used by a requestor 602 or a representative of the requestor 602 to order goods or services from a vendor 604. The system includes a billing module having functionality for billing, billing presentment, charges, pricing, and vendor setup 606, such as is provided by REALPayments, made by Ocwen Financial Corporation of 1661 Worthington Rd., Suite 100, West Palm Beach, Fla. 33409, and Softrax, made by Softrax Corporation of 45 Shawmut Road, 3rd Floor, Canton, Mass. 02021. The system also includes a payment module having functionality for approval, dispute resolution, invoice, payments, and constructive receipts 608, such as is provide by REALPayments, made by Ocwen Financial Corporation of 1661 Worthington Rd., Suite 100, West Palm Beach, Fla. 33409. The system 600 also includes functionality for invoice creation. The system 600 further includes or otherwise is able to access to one or more data repositories, such as, a REALServicing database 610, a REALTrans database 612, an accounts receivable (“AR”) database 614, an accounts payable (“AP”) database 616, and a general ledger (“GL”) database 618. Features of the billing module 606, the payment module 608, and the various databases 610, 612, 614, 616, and 618 are described in copending U.S. patent application Ser. No. 09/512,845 titled “Method for Workflow Processing Through Computer Network,” filed Feb. 25, 2000; copending U.S. patent application Ser. No. 10/102,104 titled “Management and Reporting System and Process for Use with Multiple Disparate Data Base,” filed Mar. 19, 2002; copending U.S. patent application Ser. No. 10/408,079 titled “Method and Apparatus for Providing Selective Access to Information,” filed Apr. 4, 2003; copending U.S. patent application Ser. No. 10/729,019 titled “Expense Tracking, Electronic Ordering, Invoice Presentment, and Payment System and Method,” filed Dec. 8, 2003. The entirety of each of those patent applications is incorporated herein by reference.

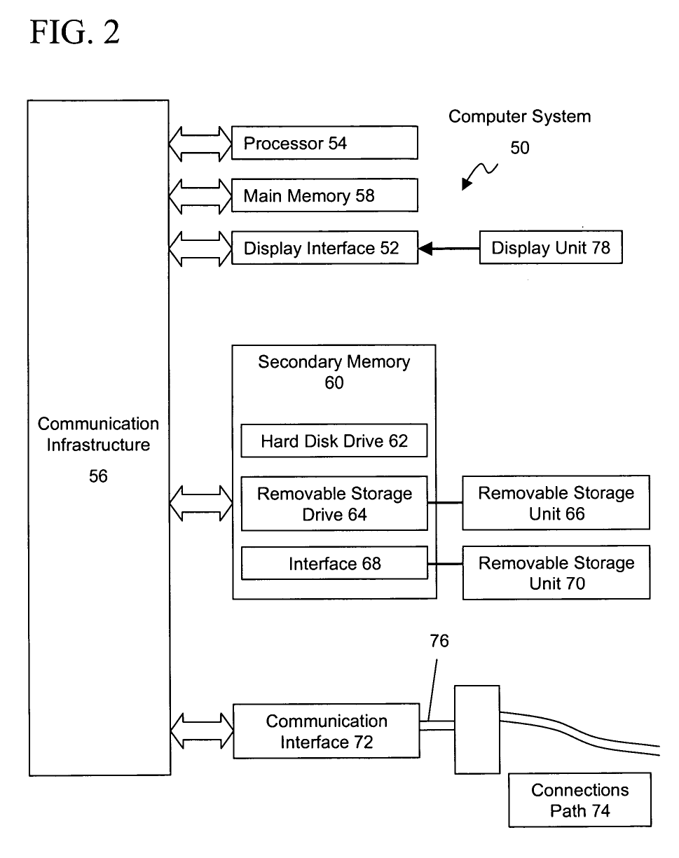

The present invention may be implemented using hardware, software or a combination thereof and may be implemented in one or more computer systems or other processing systems. In one embodiment, the invention is directed toward one or more computer systems capable of carrying out the functionality described herein. An example of such a computer system 50 is shown in FIG. 2.

Computer system 50 includes one or more processors, such as processor 54. The processor 54 is connected to a communication infrastructure 56 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 50 can include a display interface 52 that forwards graphics, text, and other data from the communication infrastructure 56 (or from a frame buffer not shown) for display on the display unit 78. Computer system 50 also includes a main memory 58, preferably random access memory (“RAM”), and may also include a secondary memory 60. The secondary memory 60 includes, for example, a hard disk drive 62 and/or a removable storage drive 64, representing a floppy disk drive, a magnetic tape drive, an optical disk drive, etc. The removable storage drive 64 reads from and/or writes to a removable storage unit 66 in a well-known manner. Removable storage unit 66, represents a floppy disk, magnetic tape, optical disk, etc., which is read by and written to removable storage drive 64. As will be appreciated, the removable storage unit 66 includes a computer usable storage medium having stored therein computer software and/or data.

In alternative embodiments, secondary memory 60 includes other similar devices for allowing computer programs or other instructions to be loaded into computer system 50. Such devices include, for example, a removable storage unit 70 and an interface 68. Examples of such may include a program cartridge and cartridge interface (such as that found in video game devices), a removable memory chip (such as an erasable programmable read only memory (“EPROM”), or programmable read only memory (“PROM”)) and associated socket, and other removable storage units 70 and interfaces 68, which allow software and data to be transferred from the removable storage unit 70 to computer system 50.

Computer system 50 also includes, for example, a communications interface 72. Communications interface 72 allows software and data to be transferred between computer system 50 and external devices. Examples of communications interface 72 may include a modem, a network interface (such as an Ethernet card), a communications port, a Personal Computer Memory Card International Association (“PCMCIA”) slot and card, etc. Software and data transferred via communications interface 72 are in the form of signals 76, which may be electronic, electromagnetic, optical or other signals capable of being received by communications interface 72. These signals 76 are provided to communications interface 72 via a communications path (e.g., channel) 74. This path 74 carries signals 76 and may be implemented using wire or cable, fiber optics, a telephone line, a cellular link, a radio frequency (“RF”) link and/or other communications channels. In this document, the terms “computer program medium” and “computer usable medium” are used to refer generally to media such as a removable storage drive 64, a hard disk installed in hard disk drive 62, and signals 76. These computer program products provide software to the computer system 50. The invention is directed to such computer program products.

Computer programs (also referred to as computer control logic) are stored in main memory 58 and/or secondary memory 60. Computer programs may also be received via communications interface 72. Such computer programs, when executed, enable the computer system 50 to perform the features of the present invention, as discussed herein. In particular, the computer programs, when executed, enable the processor 54 to perform the features of the present invention. Accordingly, such computer programs represent controllers of the computer system 50.

In an embodiment where the invention is implemented using software, the software may be stored in a computer program product and loaded into computer system 50 using removable storage drive 64, hard drive 62, or communications interface 72. The control logic (software), when executed by the processor 54, causes the processor 54 to perform the functions of the invention as described herein. In another embodiment, the invention is implemented primarily in hardware using, for example, hardware components, such as application specific integrated circuits (“ASICs”). Implementation of the hardware state machine so as to perform the functions described herein will be apparent to persons skilled in the relevant art(s).

In yet another embodiment, the invention is implemented using a combination of both hardware and software.

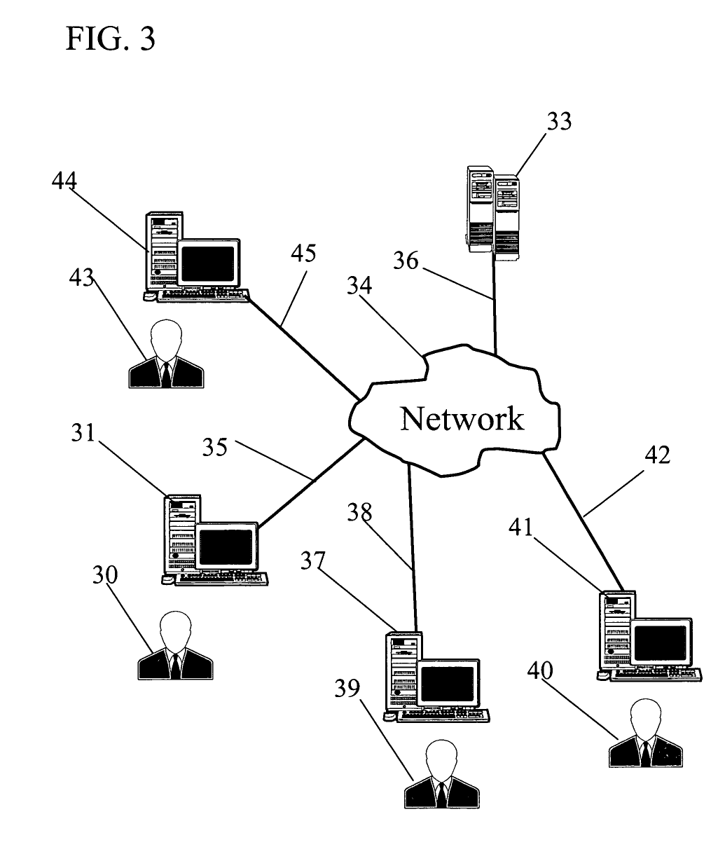

FIG. 3 presents an exemplary system diagram of various hardware components and other features in accordance with an embodiment of the present invention. As shown in FIG. 3, in an embodiment of the present invention, data and other information and services for use in the system is, for example, input by an end user 30 via a first terminal 31. The first terminal 31 is coupled to a server 33 via a network 34, such as the Internet, via couplings 35, 36. In one embodiment, a vendor 39 also is able to input information/data to the server 33 via a second terminal 37 coupled 38 to the network 34. Furthermore in one embodiment, a member of an outsourced workforce 40 inputs information/data to the server 33 via a third terminal 41 coupled 42 to the network 34, and in another embodiment, a member of a financial institution workforce 43 inputs information/data to the server 33 via a fourth terminal 44 coupled 45 to the network 34.

Each of the terminals 31, 37, 41, and 44 is or includes, for example, a personal computer (“PC”), minicomputer, mainframe computer, microcomputer, telephone device, personal digital assistant (“PDA”), or other device having a processor and input capability. The server 33, is or includes, for example, a PC, minicomputer, mainframe computer, microcomputer, or other device having a processor and a repository for data or connection to a repository for maintained data.

In operation, in an embodiment of the present invention, via the network 34, vendor data, transactional data, sub-transactional data, order data and/or other information is communicated with the server 33. The server 33 receives and resolves the transaction including triggering and resolving sub-transactions, stores data regarding the transaction, vendor, and sub-transaction, and documents the transaction (e.g., electronically).

In one embodiment of the present invention, information relating to a transaction, such as a loan, is stored electronically. This information is referred to interchangeably as a virtual loan file. Among other things, the virtual loan file enables data mining, reduces post closing quality reviews, facilitates secondary market due diligence, streamlines loan servicing functions, reduces data archive costs, reduces processing costs, automates routine and decision based processes, and reduces data entry errors.

In one embodiment, the present invention includes a branded customer portal, which enables a customer, such as a mortgage company, to tailor the look and feel of a software system, as well as the information and services provided by the software system, to the company's particular needs.

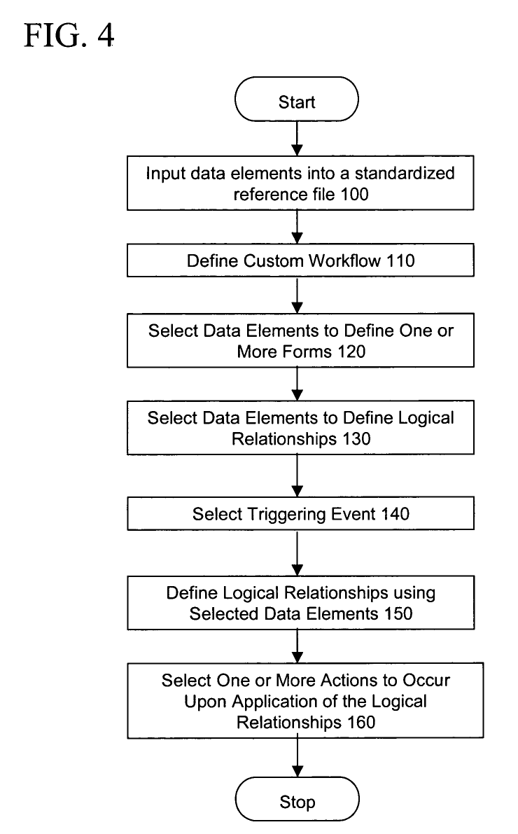

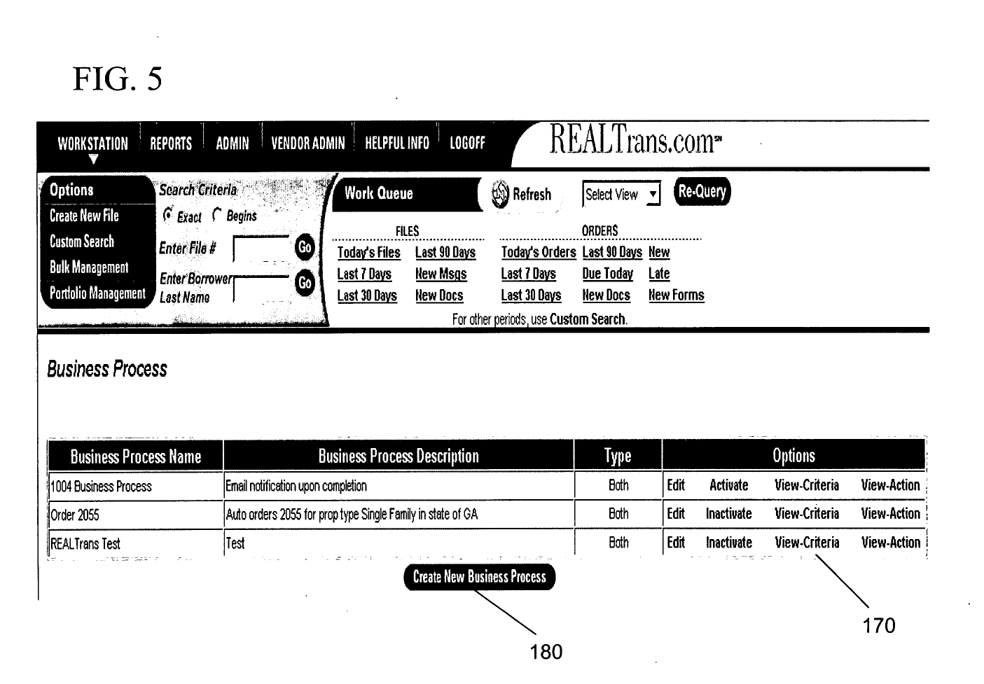

FIG. 4 illustrates an example flow diagram according to an embodiment of the present invention. The system user creates a new business process for which a customized workflow is desired. At step 100, the system user enters one or more data elements into a standardized reference file, such as a database. The type of business process is defined at 110. Next, the system user selects a type of form or report to create and one or more of the data elements for inclusion with the form or report at 120. One or more data elements are selected at step 120 to define logical relationships, described in more detail below. The system user then selects one or more triggering events that trigger application of the logical relationships at 140. The system user defines the logical relationships at 150 and one or more actions to occur after application of the logical relationships at 160. The flow diagram of FIG. 4 will now be described in more detail with reference to FIGS. 5-9, and the associated description thereof provided below.

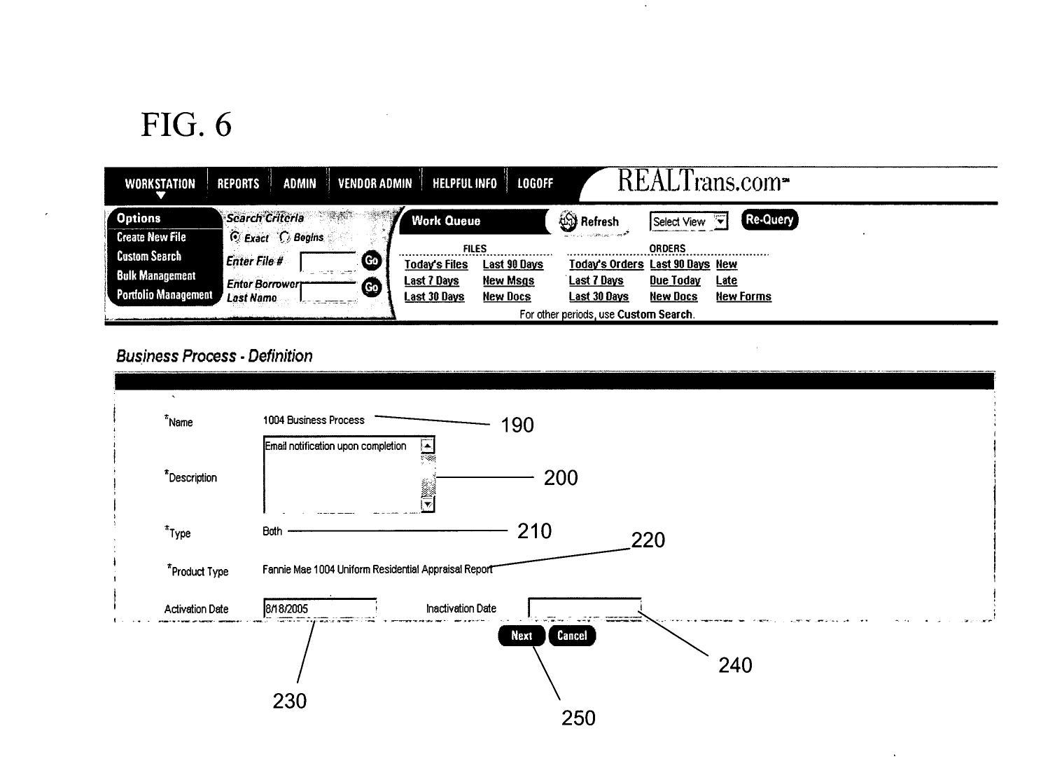

FIGS. 5-9 illustrate various GUI screen shots according to an embodiment of the present invention. FIG. 5 shows a screen shot including a table 170 containing business processes that have already been created, as well as a button 180 entitled “Create New Business Process.” In order to create a new business process, the system user selects the button 180. After selecting button 180, a new screen appears, as shown in FIG. 6. Here the system user enters a name for the business process, indicated by field 190, and a description for the business process in field 200. Next, the system user selects one or more sources of information for inclusion in one or more related forms (discussed below) associated with the business process, as well as to be used to define the logical relationships of the business process.

In one embodiment, two different sources of information or levels are provided. As described above, one level is referred to as the File level and includes, for example, basic borrower information, such as borrower name, address, telephone number, Social Security Number, and other information. The second level is referred to as Order level. The Order level includes, for example, detailed transaction-related information or data, such as, in the case of a loan transaction, credit scores, a desired loan amount, desired interest rate, and repayment terms. The File and Order level fields are selected and data for these fields are inputted by a customer desiring the transaction, an agent or employee of a financial institution, or a third party. While only two sources of data are described as being selectable for creating the logic of the business process, other sources of data are also within the scope of the invention, such as data relating to vendors selected to complete sub-transactions (e.g., a list of vendors or set of qualifications).

Referring to FIG. 6, the system user selects the source of data at field 210. As indicated in FIG. 6, “both” is selected, indicating that both the File level and the Order level data are to be used for creating the logic and one or more forms or reports of the business process. Thereafter, the system user selects the product or transaction type in field 220. The product field defines the type of business flow to be created, such as an appraisal, a loan, and a refinancing. Next, the system user selects a date on which to activate and deactivate the business process being created in fields 230 and 240, respectively. The activation date is the date on which the new business process will be available for use by the financial institution, customers, or vendors. The deactivation date is the date on which the new business process will cease to be available for use. The system user then selects the “Next” button 250.

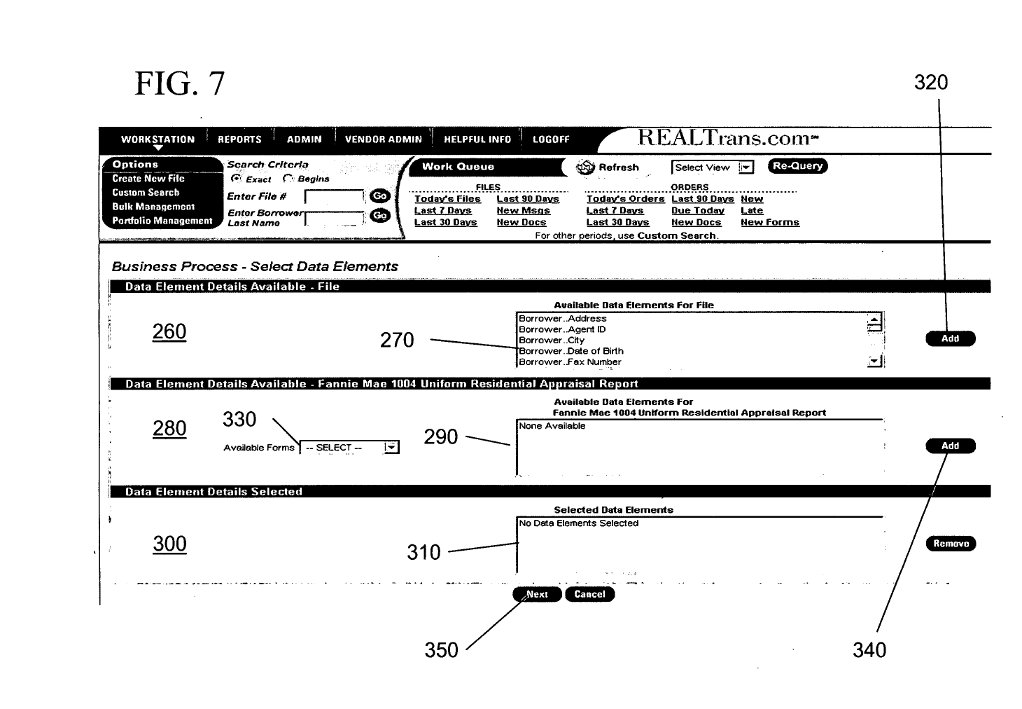

As illustrated in FIG. 7, a new GUI screen appears. The screen includes a first portion 260 containing available fields that may be used to define one or more forms related to the business process. Selectable fields are listed, for example, in a menu 270. A second portion 280 lists fields selected from the menu 270 for inclusion in a form or report associated with the business transaction, which are contained in a list 290. A third portion 300 of the screen lists fields selected for use in logical relationships (described below). The list of fields is shown in menu 310. Based on the information provided in the selected fields and the logical relationships associated therewith, the business process is programmed to perform subsequent actions. In one embodiment, these actions are performed automatically.

In order to populate a list of fields to be used in a business form or report, the system user selects a field from menu 270 and then selects the “Add” button 320. The selected field is then transferred to list 290 in the second portion 280 of the screen. The system user repeats this activity until all fields to be included in the report or form are selected or otherwise created. Next, the system user selects the type of form to be created from the “Available Forms” selection box 330. For example, the “Available Forms” selection box 330 includes “Order,” “Order Confirmation,” and “Fulfillment.” The Order form is used to order a transaction according to the new business process. The Order form includes information necessary to begin a new transaction according to the business process. For example, for an appraisal business process, the form may include the name, address, telephone number, Social Security Number, birth date, marital status, and employment information of a customer. Further, the form may include, in the case of a home appraisal, the location of the property, the size of the property, and the age of the property. The form may also include other customer information, such as credit scores and mortgage amounts. The “Order” form is transmitted to the financial institution or a vendor to request the start of a transaction. While some examples of information includable into a form have been described, it is within the scope of the invention to include any information needed or desired to order, process, or complete a transaction.

The Confirmation form is used to transfer information back to the customer, such as to indicate to the customer whether the transaction has been accepted, conditionally accepted, or declined, although other types of information may be included. Further, the Fulfillment form is used to transfer information to, for example, the customer or financial institution, from a person or party responsible for completing a sub-transaction. The Fulfillment form contains information related to a completed sub-transaction, such as the result or outcome of the completed sub-transaction.

Once the type of form has been selected from selection box 330, the system user selects one or more fields contained in the menu 290 in the second portion 280 of the screen. When a desired field is selected, the system user selects the “Add” button 340. The selected field is then transferred to the menu 310 in the third portion 300 of the screen. The system user repeats this process until all of the desired fields have been selected and added. Thereafter, the system user selects the “Next” button 350 to advance to the next screen.

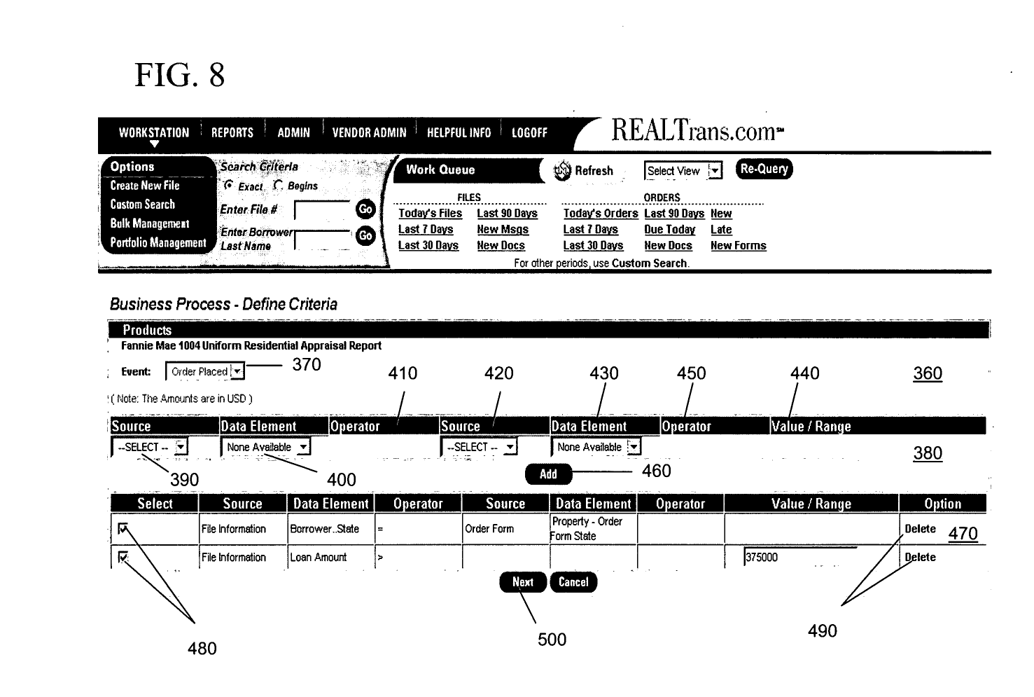

In accordance with one embodiment of the invention, FIG. 8 shows a GUI screen for defining the logical relationships or triggers for the new business process. In a first portion 360 of the screen, the system user selects an event that is used to trigger the subsequently defined logical relationships. The system user selects an event, such as from the pull-down menu 370. For example, one or more logical relationships are applied when an order is placed, an order is canceled, an order is confirmed, an order is fulfilled, or an order is declined. However, it is within the scope of the invention to include other events to trigger the logical relationships.

In a second portion 380 of the screen, the system user defines the logical relationship triggered by the occurrence of the event defined in the first portion 360 of the screen. For example, from pull-down menu 390, the system user selects the source of information, such as the File level or Order level information, described above. Next, the system user selects a data element to be used as a first part of the logical relationship, such as from pull-down menu 400. The available data elements correspond to the data elements provided in the menu 310 of the third portion 300 of the screen shown in FIG. 7. The system user then selects or enters a logical operator, such as “equal to,” “greater than,” “less than,” “greater than or equal to,” or “less than or equal to” in field 410. Next, the system user defines a second part of the logical relationship. For example, the system user selects a source of information, such as the file or order information, 420. Then, the system user selects the data element 430 to be compared to the data element selected in the first part of the logical relationship. Similarly, the data elements are, for example, selected from among the data elements provided in the menu 310 of the third portion 300 of the screen illustrated in FIG. 7.

For example, the system user may prefer to use an appraiser who lives in the same location as the subject property to conduct the appraisal, in order to reduce travel costs associated with the appraiser's travel to and from the property. Therefore, the system user selects the location of the property as the first part of the logical relationship, which, for example, is provided in the file information. Next, the system user selects the “equal to” logical operator, and, finally, the system user selects the appraiser location provided, for example, in the Order level information. Thereby, the business process selectively excludes appraisers who do not reside in the same location as the subject property.

The logical relationship may also be related to a numerical value or range of values. For example, a system user may only want a loan transaction to occur when the appraised value of collateral is at or above a certain monetary value. Therefore, the system user selects, for example, an appraisal value data element (e.g., from the pull-down menu 400) provided in the Order level information (e.g., selected from the pull-down menu 390). Next, the system user selects the “greater than” operator in field 410, and then enters the monetary value that the collateral must exceed in field 440, entitled “Value/Range.” Thereafter, the new business process will automatically make an order for the loan only when the collateral value exceeds the monetary value established. The second portion 380 of the screen also includes an additional operator field 450 usable for adding an additional logical operator to a logical relationship. That is, a logical relationship can include more than one logical operator. All logical operators are subsequently applied by the business process.

Once a logical relationship has been created, the system user selects the “Add” button 460, for example, to add the logical relationship to the business process.

A third portion 470 of the screen displays the logical relationships already created. Each of the logical relationships can be activated or deactivated using the selection box 480. Further, one or more of the logical relationships can be deleted by selecting the “Delete” field 490, for example.

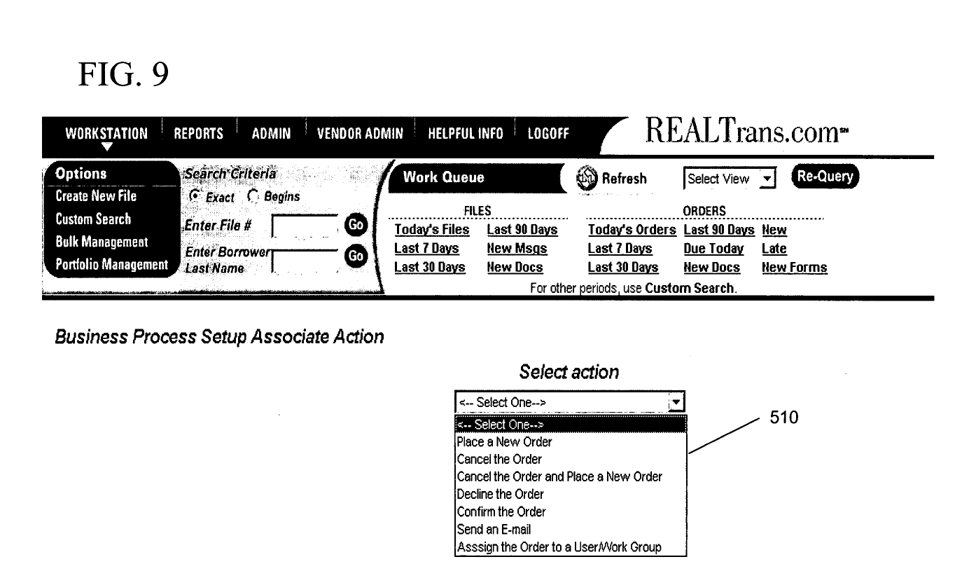

Once all of the logical relationships have been defined, the system user selects the “Next” button 500 causing the GUI screen shown in FIG. 9 to appear. Here, the system user selects one or more activities that should occur (e.g., automatically) based on the outcome of the logical relationships. The system user selects these activities, such as from pull-down menu 510. Such activities may include, without limitation, placing a new order, canceling an order, canceling an order and placing a new order, declining an order, confirming an order, sending an e-mail, or assigning an order.

Once the new business process has been created, a financial institution and its customers may use the new business process to transact one or more financial associated transactions.

The new business process creation capability reduces customer costs, due to the reduction in manual processes, and also reduces erroneous product ordering (e.g., ordering the wrong set of products for a specified financial transaction). The functionality is designed also to combine comparison logic to allow, for example, automation of the order placement process.

While there has been described what are at present considered to be preferred embodiments of the present invention, it will be understood that various modifications may be made thereto, and it is intended that the appended claims cover all such modifications as fall within the true spirit and scope of the invention. Other modifications will be apparent to those skilled in the art.

What is claimed is:

1. A method for electronically facilitating a transaction between a financial institution and an end user, the method comprising:
inputting a plurality of data elements into a data repository;
selecting at least one of the plurality of data elements;
selecting at least one of the plurality of data elements;
creating at least one form, each form including the at least one of the plurality of data elements;
creating at least one decision rule using the at least one of the plurality of data elements;
selecting one or more triggering events to trigger application of the at least one decision rule; and
specifying one or more activities to be performed upon an outcome of the at least one decision rule.

2. The method according to claim 1, wherein the plurality of data elements includes at least one selected from a group consisting of file level information and order level information, wherein the file level information includes general financial information, and wherein the order level information includes detailed financial information relating to the transaction.

3. The method according to claim 1, wherein the at least one form is selected from a group consisting of an order form for ordering a sub-transaction, an order confirmation form for confirming one of acceptance, conditional acceptance, and denial of the sub-transaction, and an order fulfillment form for communicating an outcome of the sub-transaction.

4. The method according to claim 1, wherein the one or more triggering events is selected from a group consisting of ordering the transaction, ordering a sub-transaction, confirming a sub-transaction, completing a sub-transaction, canceling a sub-transaction, and declining a sub-transaction.

5. The method according to claim 1, wherein the at least one decision rule comprises:
comparing one of the plurality of data elements to another data element.

6. The method according to claim 1, wherein the at least one decision rule comprises:
comparing one of the plurality of data elements to a numerical value.

7. A system for electronically facilitating a transaction between a financial institution and an end user comprising:
means for inputting a plurality of data elements into a data repository;
means for selecting at least one of the plurality of data elements;
means for creating at least one form, each form including the at least one of the plurality of data elements;
means for creating at least one decision rule using the at least one of the plurality of data elements;
means for selecting one or more triggering events to trigger application of the at least one decision rule; and
means for specifying one or more activities to be performed upon an outcome of the at least one decision rule.

8. The system according to claim 7, wherein the plurality of data elements include at least one selected from a group consisting of file level information and order level information, wherein the file level information includes general financial information, and wherein the order level information includes detailed financial information relating to the transaction.

9. The system according to claim 7, wherein the at least one form is selected from a group consisting of an order form for ordering a sub-transaction, an order confirmation form for confirming one of acceptance, conditional acceptance, and denial of the sub-transaction, and an order fulfillment form for communicating an outcome of the sub-transaction.

10. The system according to claim 7, wherein the one or more triggering events is selected from a group consisting of ordering the transaction, ordering a sub-transaction, confirming a sub-transaction, completing a sub-transaction, canceling a sub-transaction, and declining a sub-transaction.

11. The system according to claim 7, wherein the at least one decision rule comprises:
comparing one of the plurality of data elements to another data element.

12. The system according to claim 7, wherein the at least one decision rule comprises:
comparing one of the plurality of data elements to a numerical value.

13. A system for electronically facilitating a transaction between a financial institution and an end user, the system comprising:
a processor;
a user interface functioning via the processor; and
a repository accessible by the processor;
wherein a plurality of data elements are inputted into the repository,
wherein at least one of the plurality of data elements is selected,
wherein at least one form is created, each form including the at least one of the plurality of data elements,
wherein at least one decision rule using the at least one of the plurality of data elements is created,
wherein one or more triggering events to trigger application of the at least one decision rule is selected, and
wherein one or more activities to be performed upon an outcome of the at least one decision rule is specified.

14. The system according to claim 13, wherein the processor is housed on a terminal.

15. The system according to claim 14, wherein the terminal is selected from a group consisting of a personal computer, a minicomputer, a main frame computer, a microcomputer, a hand held device, and a telephonic device.

16. The system according to claim 13, wherein the processor is housed on a server.

17. The system according to claim 16, wherein the server is selected from a group consisting of a personal computer, a minicomputer, a microcomputer, and a main frame computer.

18. The system according to claim 16, wherein the server is coupled to a network.

19. The system according to claim 18, wherein the network is the Internet.

20. The system according to claim 18, wherein the server is coupled to the network via a coupling.

21. The system according to claim 20, wherein the coupling is selected from a group consisting of a wired connection, a wireless connection, and a fiberoptic connection.

22. The system according to claim 13, wherein the repository is housed on a server.

23. The system according to claim 22, wherein the server is coupled to a network.

24. A computer program product comprising a computer usable medium having control logic stored therein for causing a computer to facilitate a transaction between a financial institution and an end user, the control logic comprising:
a first computer readable program code means for inputting a plurality of data elements into a data repository;
a second computer readable program code means for selecting at least one of the plurality of data elements;
a third computer readable program code means for creating at least one form, each form including the at least one of the plurality of data elements;
a fourth computer readable program code means for creating at least one decision rule using the at least one of the plurality of data elements;
a fifth computer readable program code means for selecting one or more triggering events to trigger application of the at least one decision rule; and
a sixth computer readable program code means for specifying one or more activities to be performed upon an outcome of the at least one decision rule.

25. The computer program product according to claim 24, wherein the plurality of data elements include at least one selected from a group consisting of file level information and order level information, wherein the file level information includes general financial information, and wherein the order level information includes detailed financial information relating to the transaction.

26. The computer program product according to claim 24, wherein the at least one form is selected from a group consisting of an order form for ordering a sub-transaction, an order confirmation form for confirming one of acceptance, conditional acceptance, and denial of the sub-transaction, and an order fulfillment form for communicating an outcome of the sub-transaction.

27. The computer program product according to claim 24, wherein the one or more triggering events is selected from a group consisting of ordering the transaction, ordering a sub-transaction, confirming a sub-transaction, completing a sub-transaction, canceling a sub-transaction, and declining a sub-transaction.

28. The computer program product according to claim 24, wherein the at least one decision rule comprises:
comparing one of the plurality of data elements to another data element.

29. The computer program product according to claim 24, wherein the at least one decision rule comprises:
comparing one of the plurality of data elements to a numerical value.
